(19) United States
(12) Patent Application Publication
(10) Pub. No.: US 2015/0349343 A1
(43) Pub. Date: Dec. 3, 2015

(54) Low-Cost Method for Making Lithium Transition Metal Olivines with High Energy Density

(71) Applicant: DOW GLOBAL TECHNOLOGIES LLC, Midland, MI (US)

(72) Inventors: Yu-Hua Kao, Midland, MI (US); Towhid Hasan, Midland, MI (US); Robin P. Zeibarth, Midland, MI (US); Xindi Yu, Midland, MI (US); Murali G. Theivanayagam, Midland, MI (US); Lingbo Zhu, Midland, MI (US); Stacie L. Santhany, Auburn, MI (US); Jui-Ching Lin, Midland, MI (US); Ing-Feng HU, Midland, MI (US)

(21) Appl. No.: 14/410,086

(22) PCT Filed: Jun. 24, 2013
(86) PCT No.: PCT/US2013/047357

§ 371 Date: Dec. 21, 2014

Related U.S. Application Data
(60) Provisional application No. 61/664,934, filed on Jun. 27, 2012.

(51) Int. Cl. H01M 4/58; H01M 10/052; C01B 25/45

(52) U.S. Cl. CPC H01M 4/5825; C01B 25/45; H01M 10/052; C01P 2006/40; H01M 2004/028

(57) ABSTRACT

An inexpensive method for making lithium transition metal olivine particles that have high specific capacities is disclosed. The method includes the steps of: a) combining precursor materials including at least one source of lithium ions, at least one source of transition metal ions, at least one source of HₓP0₄ ions where x is 0-2 and at least one source of carbonate, hydrogen carbonate, formate and/or acetate ions in a mixture of water and a liquid cosolvent which is miscible with water at the relative proportions of water and cosolvent that are present and which liquid cosolvent has a boiling temperature of at least 130° C.; wherein the mole ratio of lithium ions to HₓP0₄ ions is from 0.9:1 to 1.2:1, and a lithium transition metal phosphate and at least one of carbonic acid, formic acid or acetic acid are formed, b) heating the resulting mixture at a temperature of up to 120° C. to selectively remove the carbonic acid, formic acid, acetic acid and/or carbon-containing decomposition products thereof from the reaction mixture, optionally remove some or all of the water from the reaction mixture and produce lithium transition metal olivine particles, and then c) separating the lithium transition metal olivine particles from the liquid cosolvent.

The present invention relates to a method for making lithium transition metal olivines and lithium battery electrode materials containing lithium transition metal olivines.

Lithium batteries are widely used as primary and secondary batteries for vehicles and many types of electronic equipment. These batteries often have high energy and power densities.

Lithium transition metal compounds are commonly used as cathode materials in these batteries. Among the lithium transition metal compounds that have been described as cathode materials are rock salt-structured compounds such as LiCoO₂, spinels such as LiMn₂O₄, and olivine materials such as lithium iron phosphates, lithium cobalt iron phosphates and lithium manganese iron phosphates. For example, LiFePO₄ is known as a low cost material that is thermally stable and has low toxicity and high rate capability (high power density). However, LiFePO₄ has a relatively low working voltage (3.4V vs. Li+/Li) and because of this has a low energy density. In principle, the working voltage and therefore the energy density can be increased by substituting manganese for some or all of the iron, and higher energy density is expected by doing so without a significant sacrifice of power capability. However, structural stability and transportation kinetics are adversely affected by replacing iron with manganese, and the specific capacities obtained have fallen significantly short of theoretical levels.

The method by which the lithium transition metal olivine electrode materials are prepared has been found to have significant effect on their performance as well as their cost. Several approaches have been tried. Among these are solid-state, sol-gel, hydrothermal reaction, microwave-assisted solvothermal and coprecipitation methods. Coprecipitation methods have the potential advantages of low raw material costs and of being easily scaled up, and so are of the most commercial interest.

Unfortunately, the coprecipitation processes previously developed have suffered from several problems. It is necessary to neutralize all three acidic hydrogens of phosphoric acid to produce the desired olivine structure. Doing so requires three moles of a base per mole of phosphoric acid. The base of choice is typically lithium hydroxide. Since only about 1 mole of lithium is present in the product, per mole of phosphate ions, the need to use three moles of lithium hydroxide to neutralize the phosphoric acid means that most of the lithium put into the process comes out as unwanted lithium salts. As lithium hydroxide is the most expensive of the raw materials, the need to use such a large excess of lithium hydroxide represents a large increase in raw material costs. In addition, the unwanted lithium salts must be recovered for recycle and re-use, or else disposed of. Recovery and recycle is complex and expensive, and disposal represents a waste of valuable lithium.

One way to reduce the amount of lithium hydroxide is to partially neutralize the phosphoric acid beforehand. Therefore, a salt such as ammonium dihydrogen phosphate can be used instead of phosphoric acid. Because the phosphoric acid is already partially neutralized, less lithium hydroxide is needed to complete the neutralization, and the lithium hydroxide requirements are reduced. However, the ammonium ions form ammonium salts which can be present as impurities in the product, and which otherwise must be removed from the waste streams to recover and recycle them, or else disposed of.

WO 2007/113624 describes a process for making a lithium transition metal olivine using acetate salts as the sources for the lithium and the transition metal. This process uses ammonium dihydrogen phosphate as the source of phosphate ions. Additional acetic acid is also present. This process produces ammonium acetate and acetic acid as reaction by-products, which remain with the reaction mixture as it undergoes a refluxing step to form crystals of the lithium transition metal olivine. These reaction by-products must be removed from the reaction solvents in order to re-use the solvents, or else the solvents must be disposed of. In either case, the process requires many processing steps and associated costs, and often does not provide a lithium transition metal olivine material that has a high enough energy density.

This invention is in one aspect a method for making lithium transition metal olivine particles, comprising the steps of:

a) combining precursor materials including at least one source of lithium ions, at least one source of transition metal ions, at least one source of HₓPO₄ ions where x is 0-2 in a mixture of water and a liquid cosolvent which is miscible with water at the relative proportions of water and cosolvent that are present and which liquid cosolvent has a boiling temperature of at least 130° C.; wherein the mole ratio of lithium ions to HₓPO₄ ions is from 0.9:1 to 1.2:1, and a lithium transition metal phosphate and reaction by-products are formed in which the reaction by-products all boil or decompose to form gases at a temperature of 120° C. or below,

b) heating the resulting mixture at a temperature of up to 120° C. to selectively remove the reaction by-products thereof from the reaction mixture, optionally remove some or all of the water from the reaction mixture and produce lithium transition metal olivine particles, and then

c) separating the lithium transition metal olivine particles from the liquid cosolvent.

In another aspect, this invention is a process for making lithium transition metal olivine particles comprising the steps of:

a) combining precursor materials including at least one source of lithium ions, at least one source of transition metal ions, at least one source of HₓPO₄ ions where x is 0-2 and at least one source of carbonate, hydrogen carbonate, formate and/or acetate ions in a mixture of water and a liquid cosolvent which is miscible with water at the relative proportions of water and cosolvent that are present and which liquid cosolvent has a boiling temperature of at least 130° C.; wherein the mole ratio of lithium ions to HₓPO₄ ions is from 0.9:1 to 1.2:1, and a lithium transition metal phosphate and at least one of carbonic acid, formic acid or acetic acid are formed,

b) heating the resulting mixture at a temperature of up to 120° C. to selectively remove the carbonic acid, formic acid, acetic acid and/or carbon-containing decomposition products thereof from the reaction mixture, optionally remove some or all of the water from the reaction mixture and produce lithium transition metal olivine particles, and then

c) separating the lithium transition metal olivine particles from the liquid cosolvent.

This process provides at least the following advantages. It is not necessary to provide more than about 1.2 moles of lithium ions (in the form of lithium precursors) per mole of HₓPO₄ ions (i.e., phosphate, hydrogen phosphate and dihydrogen phosphate ions present in the transition metal compound). The reaction produces a fugitive acid (carbonic, formic and/or acetic acids) as a reaction by-product, rather than salts. This fugitive acid and/or its carbon-containing decomposition products are volatile, and removed from the reaction mixture and the reaction solvent during the heating step (b). As a result, it is not necessary to remove salt by-products from the lithium transition metal olivine particles or from the solvent phase. In some cases, the removed acid is easily recovered by condensation once it is separated from the reaction mixture, and can be recycled or re-used easily.

Yet another advantage is that the lithium transition metal olivine formed in the process often exhibits particularly high specific capacity, even at high charge/discharge rates.

In step a) of the process of this invention, precursor materials including at least one source of lithium ions, at least one source of transition metal ions, at least one source of HₓPO₄ ions where x is 0-2 and at least one source of carbonate, hydrogen carbonate, formate or acetate ions, are combined. The precursor materials are compounds other than a lithium transition metal olivine, and are compounds which react to form a lithium transition metal olivine. Some or all of the precursor materials may be sources for two or more of the necessary starting materials.

The source of lithium ions may be, for example, lithium hydroxide or lithium dihydrogen phosphate. Lithium dihydrogen phosphate functions as a source for both lithium ions and HₓPO₄ ions, and can be formed by partially neutralizing phosphoric acid with lithium hydroxide prior to being combined with the rest of the precursor materials.

The transition metal ions preferably include at least one of iron (II), cobalt (II), and manganese (II) ions, and more preferably include iron (II) ions and either or both of cobalt (II) and manganese (II) ions. Suitable sources of these transition metal ions include iron (II) phosphate, iron (II) hydrogen phosphate, iron (II) dihydrogen phosphate, iron (II) carbonate, iron (II) hydrogen carbonate, iron (II) formate, iron (II) acetate, cobalt (II) phosphate, cobalt (II) hydrogen phosphate, cobalt (II) dihydrogen phosphate, cobalt (II) carbonate, cobalt (II) formate, cobalt (II) acetate, manganese (II) phosphate, manganese (II) hydrogen phosphate, manganese (II) dihydrogen phosphate, manganese (II) carbonate, manganese (II) hydrogen carbonate, manganese (II) formate and manganese (II) acetate. The phosphates, hydrogen phosphates and dihydrogen phosphates in the foregoing list will in addition to serving as a source of the transition metal ion also will serve as some or all of the source of HₓPO₄ ions. The carbonates, hydrogen carbonates, formates and acetates will in addition to serving as a source of the transition metal ion also will serve as some or all of the source of those respective anions. The source of the transition metal ions preferably is devoid of anions other than hydroxyl, carbonate, hydrogen carbonate, formate, acetate, phosphate, hydrogen phosphate and dihydrogen phosphate.

In preferred embodiments, the transition metal ions include two or more different transition metals, and a lithium mixed transition metal olivine is produced in the process. In such cases, one of the transition metal ions preferably is Fe(II) and the other transition metal ion is Co(II), Mn(II) or a mixture of both Co(II) and Mn(II) ions. The mole ratio of Fe to Co and/or Mn ions may be 10:90 to 90:10, and is preferably 25:75 to 75:50. An especially preferred molar ratio of Fe to Co and/or Mn ions is 25:75 to 50:50.

The source of carbonate, hydrogen carbonate, formate and/or acetate ions may be any of the transition metal carbonate, transition metal hydrogen carbonate, transition metal formate or transition metal acetate compounds described before, as well as formic acid and acetic acid. It is preferred not to use free formic acid and/or acetic acid as sources of formate and/or acetate ions. Mixtures of any two or more of the foregoing can be used. The source of carbonate, hydrogen carbonate, formate and/or acetate ions is preferably devoid of cations other than hydrogen, lithium, and the transition metal ions that form part of the olivine-type transition metal phosphate product. In particular, the source of carbonate, hydrogen carbonate, formate and/or acetate ions preferably is devoid of ammonium, phosphonium, sulfonium, alkali metal ions, alkaline earth ions, or other metals except for the transition metal ions that form part of the olivine-type transition metal phosphate product.

The source of HₓPO₄ ions may be lithium hydrogen phosphate, lithium dihydrogen phosphate, any of the transition metal phosphates, transition metal hydrogen phosphates and transition metal dihydrogen phosphates described before, as well as phosphoric acid. The source of HₓPO₄ ions preferably is devoid of cations other than hydrogen, lithium, and the transition metal ions that form part of the olivine-type transition metal phosphate product. In particular, the source of HₓPO₄ ions preferably is devoid of ammonium, phosphonium, sulfonium, alkali metal ions, alkaline earth ions, or other metals except for the transition metal ions that form part of the olivine-type transition metal phosphate product.

The mole ratio of lithium ions to HₓPO₄ ions is 0.9:1 to 1.2:1, preferably from 0.95:1 to 1.1:1, more preferably from 1.0:1 to 1.05:1.

The mole ratio of transition metal ions to HₓPO₄ ions is from 0.75:1 to 1.25:1, preferably from 0.85:1 to 1.25:1, more preferably from 0.9:1 to 1.1:1.

Together, enough lithium and transition metal ions are provided to fully neutralize the HₓPO₄ ions to form phosphates.

Preferably the mole ratio of carbonate, hydrogen carbonate, formate and/or acetate ions to HₓPO₄ ions is from 1:1 to 2.5:1, preferably 1.5:1 to 2:1.

Step a) of the process is performed in a mixture of water and a cosolvent. The cosolvent is material which has a melting temperature of 60° C. or less, preferably 25° C. or less, and a boiling temperature of at least 130° C., preferably at least 180° C. The cosolvent is miscible with water at the relative proportions of water and cosolvent that are present. By miscible, it is meant simply that the water and cosolvent form a single phase upon mixing.

The water preferably is deionized and deoxygenated.

The cosolvent preferably contains one or more hydroxyl groups, preferably at least two hydroxyl groups and especially exactly two hydroxyl groups.

Examples of suitable cosolvents include ethylene glycol, diethylene glycol, triethylene glycol, tetraethylene glycol, propylene glycol, dipropylene glycol, tripropylene glycol, tetrapropylene glycol, 1,4-butane diol, other polyalkylene glycols having a molecular weight up to about 1000, glycerin, trimethylolpropane, and the like. Diethylene glycol is a preferred cosolvent. Two or more cosolvents can be present.

Other suitable cosolvents include dimethylsulfoxide, 2-methoxyethanol, 2-ethoxyethanol, and the like.

The mixture of water and cosolvent may contain from 25 to 75% by weight water, preferably 33 to 67% by weight water, more preferably from 40 to 60% by weight water, based on the combined weight of water and cosolvent.

The raw materials, water and solvents introduced into step a) of the process preferably are devoid of cations other than hydrogen, lithium, and the transition metal ions that form part of the lithium transition metal olivine product. In particular, these materials preferably are devoid of ammonium, phosphonium, sulfonium, alkali metal ions, alkaline earth ions, or other metals except for the transition metal ions that form part of the lithium transition metal olivine product. Similarly, the raw materials, water and solvents introduced into step a) of the process preferably are devoid of inorganic anions other than HₓPO₄, hydroxyl, formate, acetate, hydrogen carbonate and carbonate anions.

For purposes of this invention, a material or mixture of materials is considered to be “devoid” of a second material if that second material constitutes no more than 0.25% of the weight thereof, preferably no more than 0.1% of the weight thereof.

The materials taken into step a) may include a small quantity of an antioxidant, preferably an organic antioxidant such as ascorbic acid, to prevent oxidation of the transition metals to higher oxidation states.

Step a) can be performed by combining the starting materials in various ways. In general, the order of addition of the starting materials is not important, so long as a lithium transition metal phosphate forms. The lithium transition metal phosphate formed in this step may not have an olivine structure, or may only partially have an olivine structure. Thus, for example, the precursors can be combined in any of the following manners:

1) Form a solution of the transition metal ion precursor(s) in water or a mixture of water and cosolvent; add phosphoric acid solution in water or a mixture of water and cosolvent; then add lithium hydroxide solution in water or a mixture of water and cosolvent. In this method, the transition metal ion precursor(s) preferably are carbonate, hydrogen carbonate, formate and/or acetate salts.

2) Form a solution of the transition metal ion precursor(s) in water or a mixture of water and cosolvent; add a lithium hydroxide solution in water or a mixture of water and cosolvent; then add a phosphoric acid solution in water or a mixture of water and cosolvent. In this method, the transition metal ion precursor(s) preferably are carbonate, hydrogen carbonate, formate and/or acetate salts. This method is less preferred due to the formation of an impurity phase.

3) Form a solution of the transition metal ion precursor(s) in water or a mixture of water and cosolvent; combine lithium hydroxide and phosphoric acid in water or a mixture of water and cosolvent; then add the lithium hydroxide/phosphoric acid solution to the solution of the transition metal ion precursors. The transition metal ion precursor(s) in this case preferably are carbonate, hydrogen carbonate, formate and/or acetate salts.

4) Form a first solution of iron (II) dihydrogen phosphate, iron (II) hydrogen phosphate and/or iron (II) phosphate in water or a mixture of water and the cosolvent. This can be done, for example, by dissolving iron metal in phosphoric acid. Separately form a second solution of one or more of cobalt (II) carbonate, cobalt (II) formate, cobalt (II) acetate, manganese (II) carbonate, manganese (II) hydrogen carbonate, manganese (II) formate and manganese (II) acetate in water or a water/cosolvent mixture. Add lithium hydroxide or solution thereof in water or a water/cosolvent mixture to the second solution. Combine the first and second solutions.

5) Form a first solution of iron (II) dihydrogen phosphate, iron (II) hydrogen phosphate and/or iron (II) phosphate in water or a mixture of water and the cosolvent. This can be done, for example, by dissolving iron metal in phosphoric acid. Add lithium hydroxide or solution thereof in water or a water/cosolvent mixture. Form a second solution of one or more of cobalt (II) carbonate, cobalt (II) formate, cobalt (II) acetate, manganese (II) carbonate, manganese (II) hydrogen carbonate, manganese (II) formate and manganese (II) acetate in water or a water/cosolvent mixture. Combine the first and second solutions.

Step a) can be performed using other orders of addition of the starting materials.

Step a) can be performed at any temperature below 100° C. A preferred temperature is 15° C. to 95° C. and a more preferred temperature is 20 to 90° C. An especially preferred temperature is 60 to 90° C.

Step a) is preferably performed with agitation to thoroughly mix the precursors and to at least partially suspend any solid materials as may begin to precipitate as step a) is performed.

In step b), the mixture resulting from step a) is then heated at a temperature of up to 120° C. to selectively remove the carbonic acid, formic acid, acetic acid, or carbon-containing decomposition products thereof from the reaction mixture. The temperature during this step is below the boiling temperature of the cosolvent, so essentially all of the cosolvent remains in the mixture during this heating step b). However, carbonic acid, formic acid, acetic acid and their carbon-containing decomposition products are not refluxed during this step, and so they are removed from the reaction mixture. Most typically, these materials are drawn off overhead as a vapor stream. In some cases, the vapor stream can be condensed if desired to recover these materials for recycling into the process or for other use.

Some cooling of the vapor removed from the reaction mixture may be performed during step b) to condense and return any of the cosolvent that vaporizes during step b), provided that carbonic acid, formic acid, acetic acid and/or their carbon-containing decomposition products are removed. Carbonic acid of course does not exist outside of aqueous solution and thus will be removed mainly as carbon dioxide. Formic acid similarly is likely to degrade and be removed as carbon dioxide, although some or all of it may be removed as formic acid.

Some or all of the water typically will be removed during step b). It is not necessary to condense any water that vaporizes during step b), or to otherwise return such removed water to the reaction mixture.

During step b), the temperature may plateau at certain temperatures corresponding to the boiling temperatures of the removed products or their azeotropes. In addition, the temperature may plateau at temperatures in the range of 100 to 120° C. as water is removed from the reaction mixture. It general, it is preferred to avoid superheating during step b), i.e., to allow the temperature of the reaction mixture to reach that of the lowest-boiling component thereof (or lowest-boiling azeotrope), and, as such low-boiling components and/or azeotropes are removed, allow the temperature to rise to that of the next-lowest boiling component or azeotrope, and so on, until the carbonate, hydrogen carbonate, formic acid, acetic acid and/or their carbon-containing decomposition products are removed. Carbonic acid, formic acid, acetic acid and their decomposition products typically are essentially fully volatilized by the time the temperature reaches 110-120° C. Once these materials are removed, continued heating without reflux will increase the temperature of the reaction mixture as water continues to be removed.

Step b) preferably is continued until at least 95%, more preferably at least 99% of the carbon from the carbonic acid, formic acid, acetic acid or their respective decomposition products is removed from the reaction mixture obtained from step a).

The concentration of carbon from the carbonic acid, formic acid, acetic acid or their respective decomposition products preferably is reduced in step b) to no greater than 0.1% by weight based on the weight of the reaction mixture.

Step b) can be performed at atmospheric, subatmospheric or superatmospheric pressure, provided that, under the pressure conditions encountered, the carbonic acid, formic acid, acetic acid or their respective carbon-containing decomposition products are volatile. It is preferred that the temperature and pressure conditions are selected together such that the cosolvent does not boil; however, if the cosolvent boils, the cosolvent vapor can be condensed and returned to the reaction mixture.

Once step b) is completed, the reaction mixture contains cosolvent and a lithium transition metal phosphate, which may at this point in the process may only partially have an olivine structure. The lithium transition metal phosphate may be in the form of a precipitate. The reaction mixture typically will contain some water which is not removed during step b), and may contain some quantity of unreacted or partially starting materials. The lithium transition metal olivine can be removed from the cosolvent (and any remaining water) once the carbonic acid, formic acid, acetic acid and/or their respective carbon-containing decomposition products are removed.

However, it is preferred to continue heating the mixture for a period of time after step b) is completed. Further heating the reaction mixture favors the development of the desired olivine-type lithium transition metal phosphates that exhibit surprisingly high charge/discharge capacities. Therefore, in a preferred process, the reaction mixture is heated to a temperature of at least 110° C. for a period of at least 30 minutes after step b) is completed. The temperature during this additional heating step may be as high as the boiling temperature of the cosolvent, although a preferred temperature is up to 200° C. and a more preferred temperature is up to 180° C. As this additional heating step is performed, water may continue to be removed, which in turn gradually increases the boiling temperature of the remaining liquid. The additional heating step may be performed under reflux or partial reflux conditions, to capture all or a part of the water that remains after step b) has been completed. This additional heating step may continue for up to 24 hours or more, but a more preferred time is up to 6 hours, up to 4 hours, or up to 2 hours.

At the conclusion of the process, the product lithium transition metal olivine particles can be separated from the cosolvent using any convenient liquid-solid separation method such as filtration, centrifugation, and the like. The separated solids may be dried to remove residual water and cosolvent. This drying can be performed at elevated temperature (such as from 50 to 250° C.) and is preferably performed under subatmospheric pressure. The solids may be washed one or more times if desired with the cosolvent, water, a water/cosolvent mixture or other solvent for the cosolvent, prior to the drying step.

The product is formed as particles that may have flake-like, rod-like or other morphologies and preferably have particle sizes of 100 nm or below.

The lithium transition metal olivine produced in the process is useful as an electrode material, particularly as a cathode material, in various types of lithium batteries. It can be formulated into electrodes in any convenient manner, typically by blending it with a binder, forming a slurry and casting it onto a current collector. The electrode may contain particles and/or fibers of an electroconductive material such as graphite, carbon black, carbon fibers, carbon nanotubes, metals and the like. The lithium transition metal olivine particles may be formed into a nanocomposite with graphite, carbon black and/or other conductive carbon using, for example, ball milling processes as described in WO 2009/127901. Such a nanocomposite preferably contains at least 70% by weight of the lithium transition metal olivine particles, more preferably at least 75% by weight thereof, and up to 30%, more preferably 1 to 25% by weight of carbon.

The olivine-type lithium transition metal phosphate produced in the process of this invention often exhibits a surprisingly high specific capacity, which is often close to theoretical for the particular selection and proportions of transition metal(s) in the olivine particles. Specific capacity is measured using half-cells at 25° C. on electrochemical testing using a Maccor 4000 electrochemical tester or equivalent electrochemical tester, using, in order, discharge rates of C/10, 1C, 5C, 10C and finally 0.1C. The lithium transition metal olivine produced in accordance with the invention may have a specific capacity of at least 80%, at least 90% or even at least 93% of the theoretical capacity on the repeat C/10 discharge rate. For example, a Li₍₁₋ₓ₎Mn_{0.75}Fe_{0.25}PO₄ olivine made in accordance with the invention may exhibit, for example, a specific capacity of at least 140 mAh/g, at least 150 mAh/g, at least 155 mAh/g or even at least 160 mAh/g at the repeat C/10 discharge rate, which values are close to the theoretical value of approximately 170 mAh/g.

A lithium battery containing such a cathode can have any suitable design. Such a battery typically comprises, in addition to the cathode, an anode, a separator disposed between the anode and cathode, and an electrolyte solution in contact with the anode and cathode. The electrolyte solution includes a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for constructing same are described, for example, in U.S. Pat. No. 7,169,511. Other suitable anode materials include lithium metal, lithium alloys, other lithium compounds such as lithium titanate and certain metal oxides.

The separator is conveniently a non-electronic conductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium salts such as LiAsF₆, LiPF₆, LiPF₄(C₂O₄), LiPF₂(C₂O₄)₂, LiBF₄, LiB(C₂O₄)₂, LiBF₂(C₂O₄), LiClO₄, LiBrO₄, LiO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethyl carbonate; a dialkyl carbonate such as diethyl cabonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atom, and the like.

The battery is preferably a secondary (rechargeable) battery, more preferably a secondary lithium battery. In such a battery, the discharge reaction includes a delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are intercalated on the anode side, at the same time, lithium ions in the cathode material deintercalated into the electrolyte solution.

The battery containing a cathode which includes lithium transition metal olivine particles made in accordance with the invention can be used in industrial applications such as electric vehicles, hybrid electric vehicles, plug-in hybrid electric vehicles, aerospace vehicles and equipment, e-bikes, etc. The battery of the invention is also useful for operating a large number of electrical and electronic devices, such as computers, cameras, video cameras, cell phones, PDAs, MP3 and other music players, tools, televisions, toys, video game players, household appliances, medical devices such as pacemakers and defibrillators, among many others.

The following examples are provided to illustrate the invention, but are not intended to limit the scope thereof. All parts and percentages are by weight unless otherwise indicated.

### EXAMPLES 1 AND 2

### Example 1

0.25 mole of iron (II) acetate and 0.75 mole of manganese (II) acetate are dissolved in water. To this solution is added a solution of 1 mole of lithium hydroxide in a mixture of about 30% by weight water and 70% by weight diethylene glycol. The resulting reaction mixture is heated to 100° C., and 1 mole of an 85% phosphoric acid solution in water is added over 10 minutes. The stirred reaction mixture is then heated. The temperature rises to 110° C. over about 10 minutes as acetic acid volatilizes, and then to 119° C. over the course of an additional hour as water and any remaining acetic acid are removed. The reaction mixture is then set to reflux and refluxed for 2 hours, during which time the temperature increases to about 180° C. as more water is lost. The resulting product mixture is cooled, washed with water, filtered, washed again, filtered again. The resulting lithium iron manganese olivine particles are then dried at 80° C. under vacuum. X-ray diffraction shows a pure olivine lithium iron manganese phosphate material. On scanning transmission microscopy, the particles are seen to have a flake-like morphology. BET surface area is 31 m²/g. Tap density is about 0.8 g/cm³.

A portion of the recovered particles in each case is ball-milled with 18 weight-% high surface area carbon black (Ketjen EC-600JD) and 8 weight-% water, in the manner described in WO 2009/127901. The milling is performed at 400 rpm for 2 hours, followed by drying the resulting coated particles at 230° C. overnight under nitrogen. The resulting coated particles are mixed with vapor-grown carbon fibers and binder at a 93:2:5 weight ratio to form electrodes. Specific capacity is measured using half-cells at 25° C. using a Maccor 4000 electrochemical, using in order discharge rates of C/10, 1C, 5C, 10C and finally 0.1C. Discharge capacities at various C-rates are as indicated in Table 1 below.

Example 2 is prepared in the same general manner as Example 1, except the phosphoric acid and lithium hydroxide are mixed together (forming LiH₂PO₄) and added together to the metal acetate solution. A second sample is produced in the identical manner, except the reaction mixture is refluxed for 5 hours after the acetic acid has been removed. In each case, a pure olivine-type structure is seen on X-ray diffraction. Electrodes are formed and evaluated as before, with discharge capacities at various C-rates being as indicated in Table 1.

TABLE 1
(Targeted composition Li₍₁₋ₓ₎Mn_{0.75}Fe_{0.25}PO₄)

| | Capacity (mAh/g) | | |
|---|---|---|---|
| Discharge | | Example 2 | Example 2 |
| Rate | Example 1 | (reflux 2 hrs) | (reflux 5 hrs) |
| C/10 | 132 | 141 | 143 |
| 1 C | 127 | 136 | 137 |
| 5 C | 99 | 113 | 115 |
| 10 C | 62 | 74 | 80 |
| C/10 (repeat) | 140 | 144 | 145 |

As can be seen from the data in Table 1, very high discharge capacities are obtained with the process of this invention.

### EXAMPLE 3

0.845 g of metallic iron are dissolved in 3.62 g glacial acetic acid to produce an iron (II) acetate solution. 10.95 g of manganese (II) acetate tetrahydrate are dissolved in 30 g deionized and deoxygenated water. The two solutions are blended, and 200 g diethylene glycol are added. The resulting iron/manganese acetate solution is heated to 70° C. Separately, 6.96 g of an 85% phosphoric acid solution in water and 1.48 g lithium hydroxide in 20 grams of water are mixed. This solution is mixed to the iron/manganese acetate solution and the resulting mixture is heated at ambient pressure with stirring until the solution temperature reaches 120° C. Acetic acid and water boil off during this heating step. The resulting slurry of lithium iron manganese olivine particles is heated at 165° C. for a period of 1-3 hours, and then the solids are washed, filtered from the remaining cosolvent, and dried as in previous examples. The targeted composition for the cathode material so produced is Li₍₁₋ₓ₎Fe_{0.25}Mn_{0.75}PO₄. The discharge capacity for this example is 140 mAh/g (first C/10 discharge rate), 136 mAh/g (1C), 113 mAh/g (5C), 74 mAh/g (10C) and 143 mAh/g (2^{nd} C/10).

### EXAMPLE 4

0.884 g of metallic iron are dissolved in 10 grams deionized and deoxygenated water and 6.96 g of an aqueous phosphoric acid solution, and heated to 70-100° C. Separately, 11.06 g of manganese (II) acetate tetrahydrate are dissolved in a mixture of 30 g deionized and deoxygenated water and 200 g diethylene glycol. 1.47 g lithium hydroxide dissolved in 20 grams of water are mixed with the manganese acetate solution. The iron phosphate solution is added to the manganese acetate solution and the resulting mixture is heated at ambient pressure until the solution temperature reaches 110° C. Acetic acid and water boil off during this heating step. The reaction mixture is then refluxed for one hour at 110° C., and then further heated at 125° C. for a period of 2-24 hours. The lithium manganese iron olivine particles are filtered from the remaining cosolvent, and washed, filtered and dried as in earlier examples. The targeted composition for the cathode material so produced is Li₍₁₋ₓ₎Fe_{0.25}Mn_{0.75}PO₄. The discharge capacity for this example is 147 mAh/g (first C/10 discharge rate), 139 mAh/g (1C), 112 mAh/g (5C), 72 mAh/g (10C) and 148 mAh/g (2^{nd} C/10).

### EXAMPLE 5

1.27 g of metallic iron are dissolved in 10 grams deionized and deoxygenated water and 10.47 g of an aqueous phosphoric acid solution, and heated to 70-100° C. Separately, 16.5 g of manganese (II) acetate tetrahydrate are dissolved in a mixture of 30 g deionized and deoxygenated water and 200 g diethylene glycol. 2.25 g lithium hydroxide dissolved in a mixture of 30 grams of water and 10 grams of diethylene glycol are mixed with the manganese acetate solution. The iron phosphate solution is added to the manganese acetate solution and the resulting mixture is heated at ambient pressure until the solution temperature reaches 110° C. Acetic acid and water boil off during this heating step. The reaction mixture is then refluxed for one hour at 110° C., and then further heated at 160° C. for a period of 2-24 hours. The targeted composition for the cathode material so produced is Li₍₁₋ₓ₎Fe_{0.25}Mn_{0.75}PO₄. The lithium manganese iron olivine particles are filtered from the remaining cosolvent, and washed, filtered and dried as in earlier examples.

### EXAMPLE 6

0.864 g of metallic iron is dissolved into 10 grams deionized and deoxygenated water and 7.082 g of an aqueous phosphoric acid solution, and heated to 70-100° C. 10 g of diethylene glycol are added. Separately, 8.9 g of manganese (II) formate monhydrate are dissolved in a mixture of 46.5 g deionized and deoxygenated water and 150 g diethylene glycol at 80° C. 1.55 g lithium hydroxide dissolved in a mixture of 20 grams of water are mixed with the manganese formate solution at 75° C. The iron phosphate solution is added to the manganese formate solution at a temperature of about 90° C. and the resulting mixture is heated at ambient pressure and 115° C. for four hours to remove the formic acid and carbon-containing formic acid decomposition products. The targeted composition for the cathode material so produced is Li₍₁₋ₓ₎Fe_{0.2}Mn_{0.8}PO₄. The lithium manganese iron olivine particles are filtered from the remaining cosolvent, and washed, filtered and dried as in earlier examples.

### EXAMPLE 7

0.859 g of metallic iron is dissolved into 10 grams deionized and deoxygenated water and 7.1 g of an aqueous phosphoric acid solution, and heated to 70-100° C. 10 g of diethylene glycol are added. Separately, 11.135 g of manganese (II) acetate tetrahydrate are dissolved in a mixture of 30 g deionized and deoxygenated water and 160 g dimethylsulfoxide. 1.464 g lithium hydroxide are mixed with the manganese acetate solution at 85° C. The iron phosphate solution is added to the manganese acetate solution at a temperature of about 105° C. and the resulting mixture is heated at ambient pressure and 105° C. for two hours to remove the acetic acid. The reaction mixture is then heated another hour at 125° C. The lithium manganese iron olivine particles are filtered from the remaining cosolvent, and washed, filtered and dried as in earlier examples. The targeted composition for the cathode material so produced is Li₍₁₋ₓ₎Fe_{0.25}Mn_{0.75}PO₄.

This experiment is performed in a larger reactor than previous examples, and at a higher stirring rate. The lithium transition metal olivine particles have sizes less than 50 nm and exhibit a nanorod morphology. The particles deliver a discharge capacity of 152 mAh/g (first C/10 discharge rate), 145 mAh/g (1C), 106 mAh/g (5C), 62 mAh/g (10C) and 153 mAh/g (2^{nd} C/10).

This experiment is repeated, this time skipping the washing step and instead drying the particles at elevated temperature and subatmospheric pressure to evaporate the cosolvent. The particles deliver a discharge capacity of 159 mAh/g (first C/10 discharge rate), 155 mAh/g (1C), 135 mAh/g (5C), 90 mAh/g (10C) and 160 mAh/g (2^{nd} C/10). Not only high discharge capacity but also high rate capability is demonstrated in this example.

### EXAMPLE 8

0.038 moles of metallic iron are dissolved into an aqueous solution containing 0.159 moles of phosphoric acid. 0.121 moles of manganese carbonate are dissolved in about 100 g of a mixture of 85 weight-% diethylene glycol and 15 weight-% water. The resulting manganese carbonate solution is added to the iron/phosphoric acid solution, together with approximately another 1000 g of a mixture of 85% diethylene glycol and 15% water. The resulting mixture is stirred under nitrogen for 3 hours, during which time it thickens.

0.159 moles of lithium hydroxide is dissolved in about 200 g of a mixture of 85% diethylene glycol and 15% water, and the resulting solution stirred under nitrogen. The resulting lithium hydroxide solution is added to the iron/phosphoric acid/manganese carbonate mixture and stirred 20 minutes without heating. The solution is placed in a flask in a heating mantle which is heated to a set temperature of 260° C. over 20 minutes. The solution temperature reaches 115° C. after about 30 minutes heating, during which time the carbonate decomposition products are removed. The mixture is then refluxed at that temperature for one hour. The reflux is discontinued and temperature of the solution rises to 160° C. as water is boiled off. The reaction mixture is heated at reflux for about 90 minutes, during which time the solution temperature increases to about 180 C. The mixture is cooled under nitrogen with stirring. The lithium manganese iron olivine particles are recovered from the remaining solvent by centrifugation and dried at 80° C. under vacuum. The targeted composition of this material is Li₍₁₋ₓ₎Fe_{0.24}Mn_{0.76}PO₄. The discharge capacity for this example is 145 mAh/g (first C/10 discharge rate), 140 mAh/g (1C), 118 mAh/g (5C), 83 mAh/g (10C), and 146 mAh/g (2^{nd} C/10).

1. A method for making lithium transition metal olivine particles, comprising the steps of:
a) a) combining precursor materials including at least one source of lithium ions, at least one source of transition metal ions which includes at least one source of Fe(II) ions and at least one source of Co(II) ions, Mn(II) ions or both Co(II) and Mn(II) ions, at least one source of HₓPO₄ ions where x is 0-2 and at least one source of carbonate, hydrogen carbonate, formate and/or acetate ions in a mixture of water and a liquid cosolvent which is miscible with water at the relative proportions of water and cosolvent that are present and which liquid cosolvent has a boiling temperature of at least 130° C.; wherein the mole ratio of lithium ions to HₓPO₄ ions is from 0.9:1 to 1.2:1, and a lithium transition metal phosphate and at least one of carbonic acid, formic acid or acetic acid are formed,
b) heating the resulting mixture at a temperature of up to 120° C. to selectively remove the carbonic acid, formic acid, acetic acid and/or carbon-containing decomposition products thereof from the reaction mixture, optionally remove some or all of the water from the reaction mixture and produce lithium transition metal olivine particles, and then
c) separating the lithium transition metal olivine particles from the liquid cosolvent.

2. (canceled)

3. The method of claim 1 wherein the source of Fe(II) ions is one or more of iron (II) phosphate, iron (II) hydrogen phosphate, iron (II) dihydrogen phosphate, iron (II) carbonate, iron (II) hydrogen carbonate, iron (II) formate and iron (II) acetate, and the source of Co(II) or Mn(II) ions is selected from cobalt (II) phosphate, cobalt (II) hydrogen phosphate, cobalt (II) dihydrogen phosphate, cobalt (II) carbonate, cobalt (II) formate, cobalt (II) acetate, manganese (II) phosphate, manganese (II) hydrogen phosphate, manganese (II) dihydrogen phosphate, manganese (II) carbonate, manganese (II) hydrogen carbonate, manganese (II) formate and manganese (II) acetate.

4. The method of claim 3 wherein the source of lithium ions is lithium hydroxide, lithium hydrogen phosphate or a mixture thereof.

5. The method of claim 4 wherein the source of HₓPO₄ ions is one or more of phosphoric acid, lithium hydrogen phosphate, lithium dihydrogen phosphate, a transition metal phosphate, a transition metal hydrogen phosphate or a transition metal dihydrogen phosphate.

6. (canceled)

7. The method of claim 5 wherein the cosolvent is dimethylsulfoxide, 2-methoxyethanol or 2-ethoxyethanol.

8. The method of claim 1 wherein step a) is conducted by forming a solution of the transition metal ion precursor(s) in water or a mixture of water and cosolvent; adding a lithium hydroxide solution in water or a mixture of water and cosolvent to the transition metal ion precursor(s) solution; then adding a phosphoric acid solution in water or a mixture of water and cosolvent.

9. (canceled)

10. The method of claim 1 wherein step a) is conducted by forming a solution of the transition metal ion precursor(s) in water or a mixture of water and cosolvent; combining lithium hydroxide and phosphoric acid in water or a mixture of water and cosolvent; then adding the lithium hydroxide/phosphoric acid solution to the solution of the transition metal ion precursors.

11. (canceled)

12. The method of claim 1 wherein step a) is conducted by forming a first solution of iron (II) dihydrogen phosphate, iron (II) hydrogen phosphate and/or iron (II) phosphate in water or a mixture of water and the cosolvent, separately forming a second solution of one or more of cobalt (II) carbonate, cobalt (II) formate, cobalt (II) acetate, manganese (II) carbonate, manganese (II) hydrogen carbonate, manganese (II) formate and manganese (II) acetate in water or a water/cosolvent mixture, adding lithium hydroxide or a solution thereof in water or a water/cosolvent mixture to the second solution and combining the first and second solutions.

13. (canceled)

14. The method of claim 1 wherein step a) is conducted by forming a first solution of iron (II) dihydrogen phosphate, iron (II) hydrogen phosphate and/or iron (II) phosphate in water or a mixture of water and the cosolvent, adding lithium hydroxide or solution thereof in water or a water/cosolvent mixture, forming a second solution of one or more of cobalt (II) carbonate, cobalt (II) formate, cobalt (II) acetate, manganese (II) carbonate, manganese (II) hydrogen carbonate, manganese (II) formate and manganese (II) acetate in water or a water/cosolvent mixture and combining the first and second solutions.

15. (canceled)

16. The method of claim 1 wherein the reaction mixture is heated to a temperature of at least 110° C. for a period of at least 30 minutes after step b) is completed and before step c).

17. The method of claim wherein the precursor materials, water and liquid cosolvent introduced into step a) are devoid of cations other than hydrogen, lithium, and the transition metal ions that form part of the lithium transition metal olivine product and are devoid of inorganic anions other than HₓPO₄, hydroxyl, formate, acetate, hydrogen carbonate and carbonate anions.

18-20. (canceled)

21. (canceled)

22-23. (canceled)

24. The lithium transition metal olivine particles of claim 21 wherein the transition metal is iron and manganese at a molar ratio of 25:75 and which has a specific capacity of at least 140 mAh/g at a second discharge rate of C/10.

25. (canceled)
